(19) United States
(12) Patent Application Publication
(10) Pub. No.: US 2004/0033353 A1
(43) Pub. Date: Feb. 19, 2004

(54) Adhesive tape

(76) Inventor: Kwang Ho You, Namdong-ku (KR)

Correspondence Address: ANDERSON KILL & OLICK, P.C., 1251 Avenue of the Americas, New York, NY, 10020, US

(21) Appl. No.: 10/098,666

(22) Filed: Mar. 14, 2002

(51) Int. Cl. B32B 7/12

(52) U.S. Cl. 428/343

(57) ABSTRACT

Provided is an adhesive tape which can be protected by an adhesive material to be used in sealing an envelope, for example, in which adhesive components formulated in the adhesive material can remain in a moistened condition, and which can be easily replaced by allowing easy separation from and connection to casings for the adhesive tape.

### BACKGROUND OF THE INVENTION

1. Field of the Invention

The present invention relates to an adhesive tape and more particularly, to an adhesive tape which can be protected by an adhesive material to be used in sealing an envelope, for example, in which adhesive components formulated in the adhesive material can remain in a moistened condition, and which can be easily replaced by allowing easy separation from and connection to casings for the adhesive tape.

2. Description of the Related Art

In sealing an envelope, adhesive paste (or starch) is generally applied to the flap of the envelope. In order to promote a convenient, easy use of the adhesive paste, an applying device for storing the adhesive paste is usually used. However, quite a much time is disadvantageously required to dry the adhesive paste after application.

Thus, use of an adhesive tape, not requiring a dry time after application, unlike the adhesive paste, is preferred. The adhesive tape is generally used in such a manner that it is wound around a roller to then be installed inside casings, and it is unwound to be applied to a target article through a tape outlet formed at the casings via a predetermined path.

Adhesive components included in the adhesive tape become gradually dry from the tape outlet side of the casing over time, so that the adhesive tape cannot be used any longer. Otherwise, foreign matter such as dust may stick to the adhesive tape exposed to the outside by the tape outlet.

To solve the above-described drawbacks, various structures for adhesive tapes, including a protective cap installed at a tape outlet side, have been conventionally proposed However, such a protective cap is liable to loss. One attempt for avoiding loss of the protective cap is to movably install the protective cap at the tape outlet. However, this attempt is also disadvantageous because a structure for installing the protective cap is quite complicated. Also, since separation and connection of casings for the adhesive tape is not possible, a refill type structure cannot be realized.

### SUMMARY OF THE INVENTION

To solve the above-described problems, it is an object of the present invention to provide an adhesive tape which can be protected by an adhesive material to be used in sealing an envelope, for example, in which adhesive components contained in the adhesive material can remain in a moistened condition, and which can be easily replaced by allowing easy separation from and connection to casings for the adhesive tape.

To accomplish the above object, there is provided an adhesive tape coated with an adhesive material adhered to a predetermined surface of an object to be adhered while passing through a predetermined path, the adhesive tape including a pair of casings which are large enough to accommodate the tape, are vertically separable from each other around a rear end and connected to each other by a fixing ridge and a hooking groove, and which have a tape outlet provided at each leading edge thereof and hinge holes formed at one surface of the tape outlet, a protective cap rotatably connected to the tape outlet side of the casings to protect the adhesive material coated on the tape, and having hinge pieces which project up and down, the hinge pieces formed at one end of the protective cap, and connected to the hinge holes simultaneously when the casings are connected to each other, a refill frame shaped of a panel so as to be mounted inside the casings, having a tape guide protruding at the tape outlet to allow the tape to be drawn out therethrough, and having a guide projection integrally formed therein to guide the movement of the tape through the tape guide, and two or more first and second toothed gears each rotatably installed in the refill frame to support a feed roller on which the tape is wound and to make a withdrawal roller for withdrawing the tape unwound from the feed roller rotate in a direction opposite to that of the feed roller.

The protective cap preferably has a fixing hole formed at one surface of the protective cap at the lateral surfaces of the casings so that the protective cap remains at a state in which it is moved to the lateral surfaces of the casings, and a fixing projection fitted into the fixing hole, is formed at the lateral surfaces of the casings.

The adhesive tape may further include a backward rotation-preventing device configured such that a latch is formed in the refill frame and a latch gear is formed at the rear surface of the first toothed gear for supporting the feed roller to make the first and second toothed gears rotate in one direction only.

The refill frame preferably has arc-shaped projections provided upwardly at both sides of the tape guide.

Also, the adhesive tape may further include a support frame installed in the refill frame, having a coupling hole formed at the center thereof and four blades formed radially around the coupling hole to securely support the feed roller and the withdrawal roller.

### BRIEF DESCRIPTION OF THE DRAWINGS

The above objects and advantages of the present invention will become more apparent by describing in detail preferred embodiments thereof with reference to the attached drawings in which:

FIG. 1 is a perspective view of an external appearance of an adhesive tape according to the present invention;

FIG. 2 is an exploded perspective view of the adhesive tape according to the present invention;

FIG. 3 is a plan view of the adhesive tape according to the present invention;

FIG. 4 is a perspective view of the structure of a refill frame installed inside the adhesive tape according to the present invention;

FIG. 5 is a front view of the adhesive tape according to the present invention;

FIG. 6 is a front view showing a state in which a support frame is installed in the refill frame for the adhesive tape according to the present invention; and

FIG. 7 is a rear view of the refill frame to illustrate a backward rotation preventing device of the adhesive tape according to the present invention.

### DETAILED DESCRIPTION OF THE INVENTION

The present invention will now be described in detail with reference to the accompanying drawings.

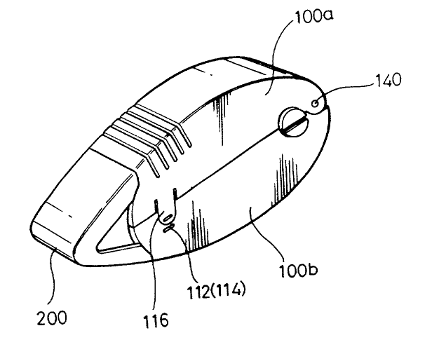

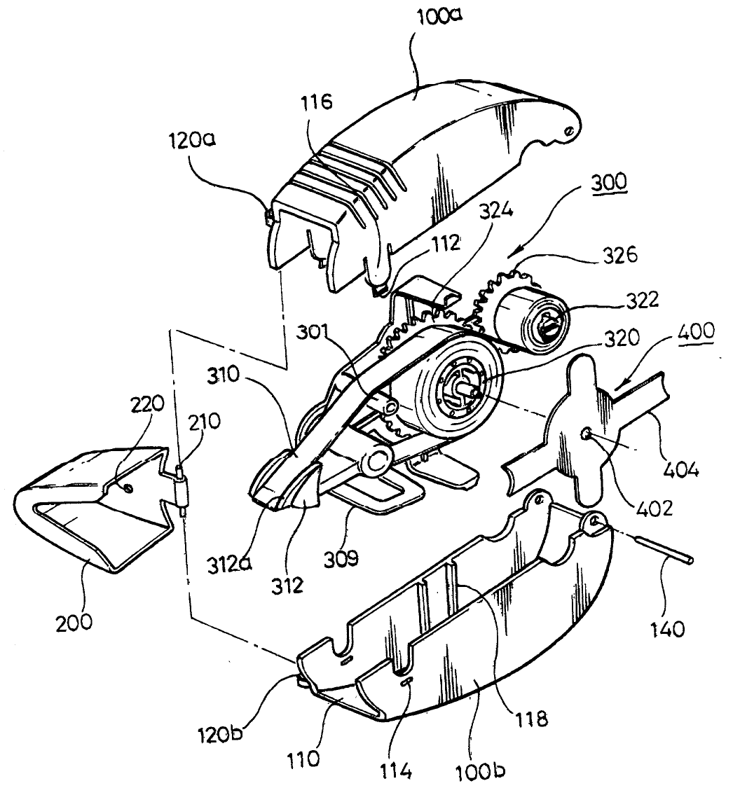

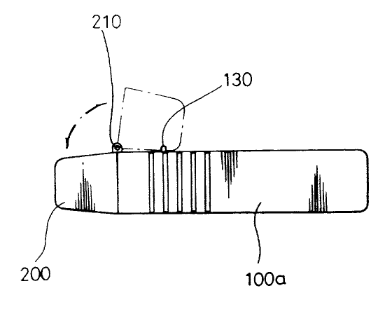

FIG. 1 is a perspective view of an external appearance of an adhesive tape according to the present invention, FIG. 2 is an exploded perspective view of the adhesive tape according to the present invention, and FIG. 3 is a plan view of the adhesive tape according to the present invention.

As shown in the drawings, the adhesive tape according to the present invention includes a pair of casings 100a and 100b of a predetermined shape, which are large enough to accommodate a refill frame 300, which are connected to be vertically separable from each other around a rear end, and which has a tape outlet 110 provided at each leading edge thereof.

The pair of casings 100a and 100b have a hooking ridge 112 and a hooking groove 114 formed to face each other, respectively, so as to be connected to each other without being separated. The hooking ridge 112 is preferably formed at an elastic arm 116 for being easily connected to or separated from the hooking groove 114.

The casings 100a and 100b of the present invention are simply detachable by means of the hooking ridge 112 and the hooking groove 114. The separation and/or connection of the casings 100a and 100b are made vertically, that is, up and down, around a hinge 130 connected to the rear ends thereof.

The reason of the foregoing is to allow a protective cap 200 connected to the tape outlet 110 provided at each leading edge, to be connected together with the casings 100a and 100b. Hinge holes 120a and 120b are vertically formed at each leading edge of the casings 100a and 100b, that is, at one surface of the tape outlet side. The hinge holes 120a and 120b are formed to allow hinge pieces 210 provided at the protective cap 200 to be connected so that the protective cap 200 rotatably moves.

The above-described configuration for simple separation and connection of the casings 100a and 100b makes it possible for a tape coated with an adhesive material to be fully used. Once the tape is used up, only the used tape is replaced with new one to be reused.

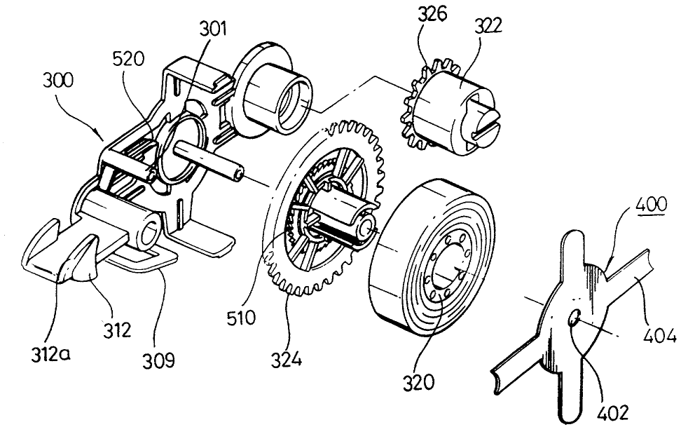

For replacement of the tape, the adhesive tape is mounted on the refill frame 300 and the refill frame 300 is detachably installed inside the casings 100a and 100b. In order to realize easy separation/connection of the refill frame 300 from/to the casings 100a and 100b, a guide projection 118 is preferably formed on inner surface of the casing 100b. The lateral surface of the refill frame 300 is guided to the guide projection 118 to then be insertion-connected so that the refill frame 300 can be connected at a proper position. The refill frame 300 will later be described in detail with reference to FIGS. 4 through 7.

As described above, the present invention also provides the protective cap 200 for protecting a tape 310 coated with an adhesive material. The protective cap 200 is rotatably installed at a portion of the tape outlet 110 of the casings 100a and 100b. When the adhesive tape is stored without being used, the protective cap 200 is connected to the tape outlet 110 of the casings 100a and 100b. On the other hand, when the adhesive tape is used, the protective cap 200 rotatably moves toward the lateral surfaces of the casings 100a and 100b. Since the protective cap 200 is connected to the tape outlet 110 of the casings 100a and 100b, the adhesive material applied to the tape can be protected and the adhesive components contained in the adhesive material can be prevented from getting dry.

The hinge pieces 210 projecting up and down, are formed at one end of the protective cap 200. The hinge pieces 210 are connected to the hinge holes 120a and 120b formed at the casings 100a and 100b, respectively. When the casings 100a and 100b are connected to each other, the hinge pieces 210 of the protective cap 200 are just made to be connected with the hinge holes 120a and 120b, so that the protective cap 200 can be movably connected. In other words, since the protective cap 200 is connected at the time when the separate upper and lower casings 100a and 100b are connected to each other, the connection of the protective cap 200 can be simply made.

In order to make the protective cap 200 remain at a state in which the protective cap 200 is moved to the lateral surfaces of the casings 100a and 100b, a fixing hole 220 is formed on the lateral surface of the protective cap 200, and a fixing projection 130 fitted into the fixing hole 220 is formed on the lateral surface of the casing 100b. Thus, when the protective cap 200 moves to the lateral surfaces of the casings 100a and 100b, the fixing hole 220 is fitted into the fixing projection 130 so that the protective cap 200 remains at a state in which it is moved to the lateral surfaces of the casings 100a and 100b.

According to the present invention, adhesive components for ensuring better adhesion thereof to paper or an article to be adhered are contained in the tape mounted inside the casings 100a and 100b. The adhesive components can be protected from dust or can be prevented from getting dry by connecting the protective cap 200 of the present invention to the tape outlet side.

When the adhesive tape is not used, it is stored such that the protective cap 200 is connected to a portion of the tape outlet 110 of the casings 100a and 100b, thereby preventing the tape coated with the adhesive material from being exposed outside. On the other hand, when the adhesive tape is used, the protective cap 200 rotatably moves toward the lateral surfaces of the casings 100a and 100b, thereby preventing the protective cap 200 from being missing.

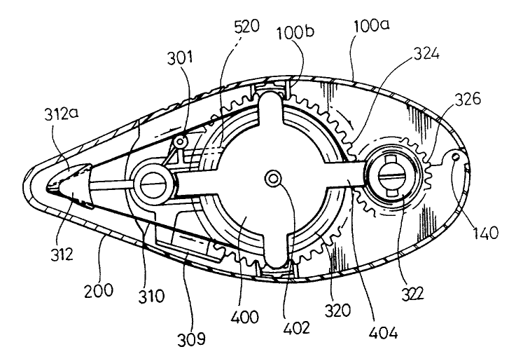

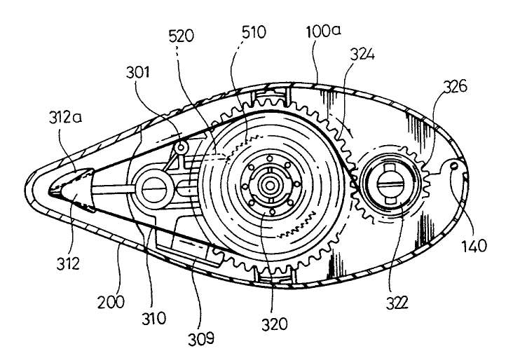

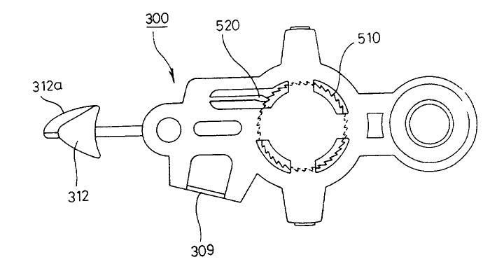

FIG. 4 is a perspective view of the structure of a refill frame installed inside the adhesive tape according to the present invention, FIG. 5 is a front view of the adhesive tape according to the present invention, FIG. 6 is a front view showing a state in which a support frame is installed in the refill frame for the adhesive tape according to the present invention, and FIG. 7 is a rear view of the refill frame to illustrate a backward rotation preventing device of the adhesive tape according to the present invention.

As shown in the drawings, the refill frame 300 is detachably installed inside the casings 100a and 100b. The tape 310 coated with an adhesive material is mounted on the refill frame 300 and is applied to a predetermined surface (e.g., a target article or paper) through the tape outlet 110 of the casings 100a and 100b via a predetermined path.

The adhesive material coated on the tape 310 can be applied to a tape containing an adhesive component used in sealing an envelope, for example, a correction tape coated with a corrective material used in correcting alphanumerical characters, a fluorescent tape, a highlighting tape, and the like.

The tape 310 mounted on the refill frame 300 is wound on a feed roller 320 in a state in which it is coated with the adhesive material. A withdrawal roller 322 on which the tape 310 unwound from the feed roller to have the adhesive material removed from the tape 310 via the predetermined path, is installed at either side of the feed roller 320.

The feed roller 320 and the withdrawal roller 322 rotate in opposite directions by at least two toothed gears 324 and 326 engaged with each other. via a predetermined path. The first and second toothed gears 324 and 326, the withdrawal roller 322 and the feed roller 320 are integrally formed with the refill frame 300 by injection-molding the refill frame 300 using a resin material.

In the refill frame 300, there is provided a tape guide 312 protruding at the tape outlet 110. The tape guide 312 allows the tape 310 to be drawn out through the tape outlet 110 of the casings 100a and 100b, and guides the movement of the tape 310. In some cases, the tape guide 312 presses the tape coated with the adhesive material on a predetermined surface of an article to be adhered or paper to peel off the adhesive material from the tape 310.

Arc-shaped projections 312a are provided upwardly at both sides of the tape guide 312, so that the tape 310 cannot be used in a backward direction. In other words, during use, the coated surface of the tape 310 is brought into contact with the predetermined surface. However, when the tape 310 is intended to be used in a backward direction, the tape 310 is not brought into contact with the predetermined surface by the projections 312a provided at the tape guide 312, disabling use of the tape 310. That is to say, a tape that has been used cannot be used in a backward direction, thereby preventing the tape from being unwound.

A guide projection 301 for allowing the tape 310 to pass through a predetermined path, is integrally formed at the upper portion of the leading edge of the refill frame 300. Also, a checking plate 309 for preventing user's hands or the casings 100a and 100b from being stained with the adhesive material coated on the adhered surface of the tape 310, is integrally formed at the lower portion of the leading edge of the refill frame 300.

In order to prevent the tape 310 wound on the feed roller 320 and the withdrawal roller 322 from being unwound outside the path and to support the feed roller 320 and the withdrawal roller 322, a support frame 400 is preferably further installed in the refill frame 300. The support frame 400 has a coupling hole 402 at the center thereof so as to be fitted to the shaft on which the feed roller 320 is mounted. Four blades 404 are formed radially around the coupling hole 402 to securely support the feed roller 320 and the withdrawal roller 322.

Also, a backward rotation preventing device for preventing the first and second toothed gears 324 and 326 from rotating in a backward direction is provided in the refill frame 300. The backward rotation preventing device makes the first and second toothed gears 324 and 326 rotate in one direction only. A latch gear 510 is integrally formed at the rear surface of the first toothed gear 324 for supporting the feed roller 320. A latch 520 with one free end, which is engaged with the latch gear 510 to allow forward rotation while preventing backward rotation, is integrally formed at the refill frame 300.

In the refill frame 300, the pre-fabricated first and second toothed gears 324 and 326 are engaged to each other. Thus, when the first toothed gear 324 having the feed roller 320 installed thereat rotates, the second toothed gear 326 engaged with the first toothed gear 324 rotates accordingly. The latch gear 310 formed at the rear surface of the first toothed gear 324 is engaged with the latch 520 formed at the refill frame 300, to allow the first and second toothed gears 324 and 326 to rotate in one direction only while preventing backward rotation.

A front end of the tape 310 is drawn out from the feed roller 320 connected to the first toothed gear 324. The drawn tape 310 is allowed to pass through the tape guide 312 and the guide projection 301 and then assembled in the refill frame 300 in a state in which it is fixed to the periphery of the second toothed gear 326 with an adhesive surface of the tape 310 interposed.

Assembling the refill frame 300 can be simplified by making the refill frame 300 positioned inside the casings 100a and 100b. The refill frame 300 provided for the purpose of refilling, is packaged by a packing device (not shown) for commercial distribution.

Since the first and second toothed gears 324 and 326 are incorporated in the refill frame 300, the refill frame 300 can be easily separated from the casings 100a and 100b for removal. The separated refill frame 300 can be recycled. In this case, the checking plate 309 formed at the lower portion of the leading edge of the refill frame 300 can prevent user's hands or the casings 100a and 100b from being stained with the adhesive material coated on the adhesive surface of the tape.

When the adhesive tape mounted in the refill frame is used up, only the refill frame 300 can be replaced. To this end, the casings 100a and 100b must be easily separated from and connected to each other. According to the present invention, since the casings 100a and 100b are simply connected to each other by the hooking ridges 112a and 112b and the hooking grooves 114a and 114b, the casings 100a and 100b can be easily separated from each other. Thus, easy replacement of the tape can be achieved.

As described above, in the adhesive tape according to the present invention, a protective cap is movably installed at either leading edge of a tape outlet in casings, so that the tape coated with an adhesive material can be protected from alien matter such as dust or can be prevented the tape from getting dry.

Also, according to the present invention, the casings are easily connected to or separated from each other, thereby easily replacing tapes when the tape is used up. That is to say, since first and second toothed gears which allow a feed roller and a withdrawal roller to rotate, are incorporated into a refill frame to be refillable. Thus, when the used tape is intended to be replaced, the refill frame incorporating the components and the tape into one body has only to be replaced. That is, the tape can be replaced faster and more easily, compared to the case of conventional adhesive tape replacement.

The adhesive tape according to the present invention has been particularly shown and described with reference to the most preferred embodiment thereof. However, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. An adhesive tape coated with an adhesive material adhered to a predetermined surface of an object to be adhered while passing through a predetermined path, the adhesive tape comprising:
a pair of casings which are large enough to accommodate the tape, are vertically separable from each other around a rear end and connected to each other by a fixing ridge and a hooking groove, and which have a tape outlet provided at each leading edge thereof and hinge holes formed at one surface of the tape outlet;
a protective cap rotatably connected to the tape outlet side of the casings to protect the adhesive material coated on the tape, and having hinge pieces which project up and down, the hinge pieces formed at one end of the protective cap, and connected to the hinge holes simultaneously when the casings are connected to each other;
a refill frame shaped of a panel so as to be mounted inside the casings, having a tape guide protruding at the tape outlet to allow the tape to be drawn out therethrough, and having a guide projection integrally formed therein to guide the movement of the tape through the tape guide; and
two or more first and second toothed gears each rotatably installed in the refill frame to support a feed roller on which the tape is wound and to make a withdrawal roller for withdrawing the tape unwound from the feed roller rotate in a direction opposite to that of the feed roller.

2. The adhesive tape of claim 1, wherein the protective cap preferably has a fixing hole formed at one surface of the protective cap at the lateral surfaces of the casings so that the protective cap remains at a state in which it is moved to the lateral surfaces of the casings, and a fixing projection fitted into the fixing hole, is formed at the lateral surfaces of the casings.

3. The adhesive tape of claim 1, further comprising a backward rotation preventing device configured such that a latch is formed in the refill frame and a latch gear is formed at the rear surface of the first toothed gear for supporting the feed roller to make the first and second toothed gears rotate in one direction only.

4. The adhesive tape of claim 1, wherein the refill frame has arc-shaped projections provided upwardly at both sides of the tape guide.

5. The adhesive tape of claim 1, comprising a support frame installed in the refill frame, having a coupling hole formed at the center thereof and four blades formed radially around the coupling hole to securely support the feed roller and the withdrawal roller.
